(19) United States
(12) Patent Application Publication
(10) Pub. No.: US 2025/0332899 A1
(43) Pub. Date: Oct. 30, 2025

(54) BATTERY ATTACHMENT STRUCTURE

(71) Applicant: ISUZU MOTORS LIMITED, Yokohama-shi (JP)

(72) Inventors: Kazuhiro UEDA, Fujisawa-shi (JP); Hiroshi YAMADA, Fujisawa-shi (JP); Shuhei KONISHI, Fujisawa-shi (JP)

(21) Appl. No.: 19/033,221

(22) Filed: Jan. 21, 2025

(30) Foreign Application Priority Data
Apr. 30, 2024 (JP) 2024-073933

(51) Int. Cl. B60K 1/04

(52) U.S. Cl. CPC B60K 1/04; B60K 2001/0455

(57) ABSTRACT

To provide a battery attachment structure that allows a battery to be continuously used even when a nut attached to the battery is worn. In view of this, in the battery attachment structure, a nut member is detachably attached to an outer surface of an outer plate of a battery; and the battery is fastened to a vehicle body frame by screwing a fastening bolt into the nut member, the fastening bolt being inserted in a fastening hole formed in the vehicle body frame.

### CROSS REFERENCE TO RELATED APPLICATIONS

This application is entitled to (or claims) the benefit of Japanese Patent Application No. 2024-073933, filed on Apr. 30, 2024, the disclosure of which including the specification, drawings and abstract is incorporated herein by reference in its entirety.

### TECHNICAL FIELD

The present disclosure relates to a structure for attaching a battery to a vehicle body frame.

### BACKGROUND ART

A drive battery for an electric vehicle or a hybrid vehicle has a large size, and is attached to a vehicle body frame with bolts. FIGS. 6 to 8 illustrate a conventional structure in which battery 100 is attached to horizontal portion 32 of vehicle body frame 30. Attachment hole 102 is formed in bottom plate 101, which is a part of the battery case of battery 100. Nut 103 is firmly fixed to the inner surface of bottom plate 101 at a position corresponding to attachment hole 102 by welding or the like.

Fastening hole 33 is formed in horizontal portion 32 of vehicle body frame 30. Fastening bolt 40 is inserted into fastening hole 33 and attachment hole 102, and is screwed into nut 103, thereby fastening battery 100 to vehicle body frame 30.

When a vehicle has travelled and the battery power has been consumed, the battery needs recharging. However, in the case where the battery is charged in the state where the battery is attached to the vehicle body frame, the vehicle cannot travel while the charging of the battery. In order to allow the vehicle to continue traveling even during battery charging, it has been considered to remove the battery to be charged from the vehicle body frame and exchange it with a charged battery so as to charge the battery removed from the vehicle body.

### SUMMARY OF INVENTION

### Technical Problem

When the battery is frequently replaced, the nut attached to the battery becomes worn. Due to the worn nut, the battery may not be attached to the vehicle body frame even if the battery itself is usable.

An object of the present disclosure is to provide a battery attachment structure that allows a battery to be continuously used even when a nut attached to the battery is worn.

### Solution to Problem

In a battery attachment structure according to the present disclosure, a nut member is detachably attached to an outer surface of an outer plate of a battery; and the battery is fastened to a vehicle body frame by screwing a fastening bolt into the nut member, the fastening bolt being inserted in a fastening hole formed in the vehicle body frame.

### Advantageous Effects of Invention

Since the nut member is detachably and exchangeably attached to the battery, the nut member can be easily exchanged when the nut is worn and becomes unusable, and thus the battery can be continuously used.

### BRIEF DESCRIPTION OF DRAWINGS

FIG. 1 is a view illustrating Embodiment 1;

FIG. 2A is a side view illustrating a nut member;

FIG. 2B is a plan view illustrating the nut member;

FIG. 3 is a view illustrating a structure in which the nut member is attached to a bottom plate;

FIG. 4 is a cross-sectional view illustrating a state in which the nut member is attached to the bottom plate;

FIG. 5 is a cross-sectional view illustrating a state in which a nut member of Embodiment 2 is attached to the bottom plate;

FIG. 6 is a view illustrating a conventional battery attachment structure;

FIG. 7 is a view illustrating a conventional battery attachment structure; and

FIG. 8 is a cross-sectional view illustrating a conventional battery attachment structure.

### DESCRIPTION OF EMBODIMENTS

Hereinafter, embodiments of the present disclosure will be described with reference to the drawings. All the embodiments described below show a specific example of the present disclosure. Therefore, each component, the disposition position and the connection form of each component, and the like illustrated in the following embodiments are examples and are not intended to limit the present disclosure. In addition, components that are not described in the independent claims among components in the following embodiments are described as optional components.

Each drawing is a schematic diagram and is not necessarily a strict illustration. In each drawing, the same reference numerals are attached to the substantially same configuration, and redundant explanations are not shown or simplified.

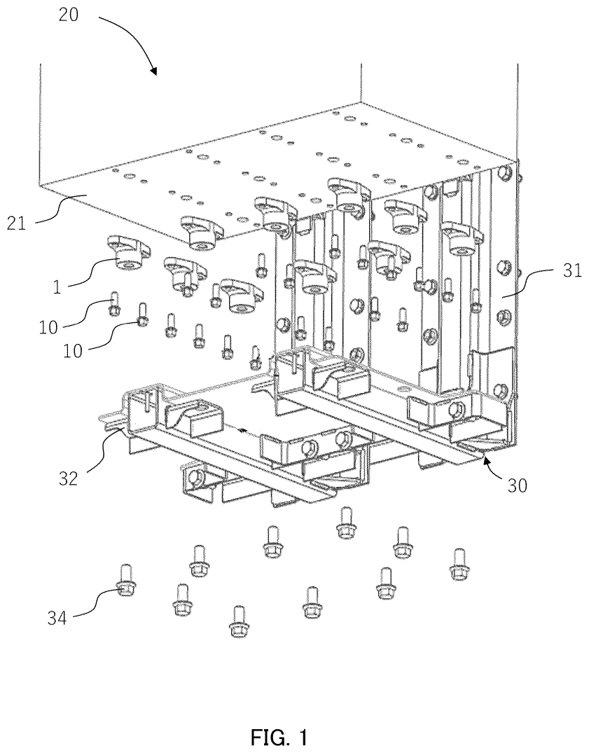

FIGS. 1 to 4 are views illustrating a structure in which battery 20 of the Embodiment 1 is attached to vehicle body frame 30. In FIG. 1, vehicle body frame 30 is a substantially L-shaped frame member including vertical portion 31 and horizontal portion 32, and battery 20 is mounted on horizontal portion 32.

A predetermined number of nut members 1 are attached, with attachment bolt 10, to the outer surface (lower surface) of bottom plate 21, which is a part of the outer plate of battery 20. Battery 20 is placed on horizontal portion 32 and attached to horizontal portion 32 with fastening bolt 34 screwed into nut member 1 from below.

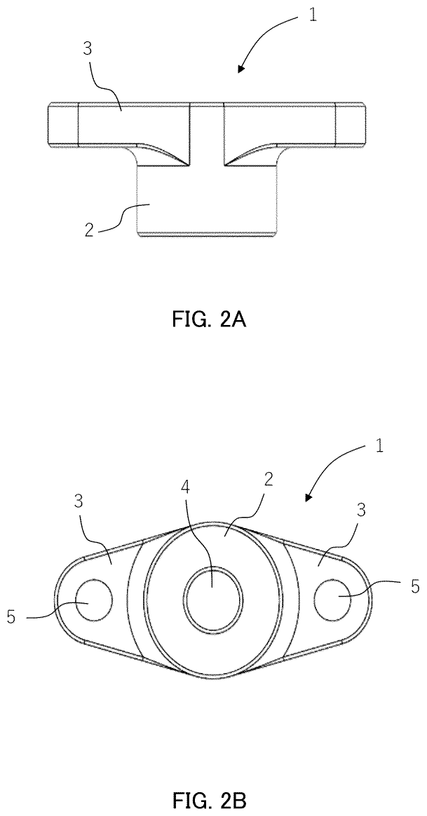

FIG. 2A is a side view illustrating nut member 1, and FIG. 2B is a bottom view illustrating the nut member. As illustrated in FIG. 2A, nut member 1 includes nut portion 2 and extension portion 3 extending laterally from the base portion (upper side in the figure) of nut portion 2. In FIG. 2B, female screw 4 is formed in the center portion of nut portion 2 in a direction perpendicular to the paper surface of the drawing. In each extension portion 3, through-hole 5 is formed in the direction perpendicular to the paper surface of the drawing. In this example, one extension portion 3 and one through-hole 5, i.e., two extension portions 3 and two through-holes 5 in total, are formed at respective positions sandwiching nut portion 2, but the number and positions of extension portions 3 and through-holes 5 may be appropriately set in accordance with the size of nut member 1 and the like.

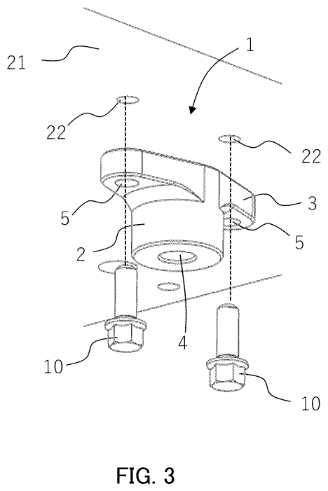

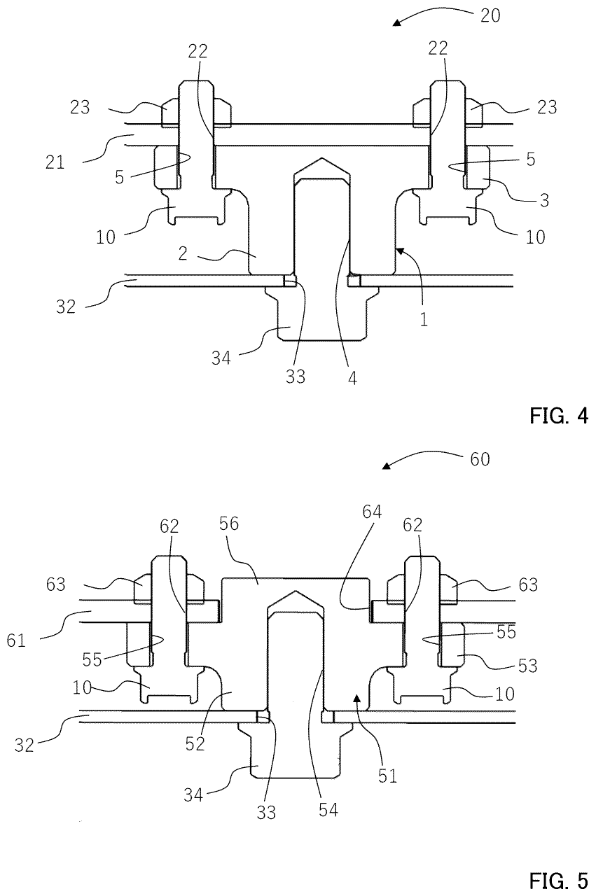

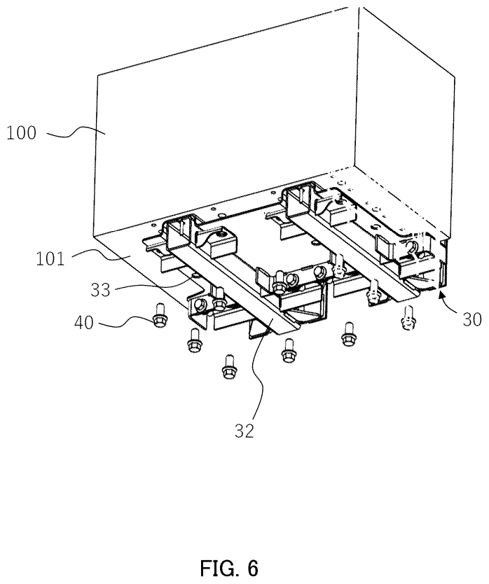

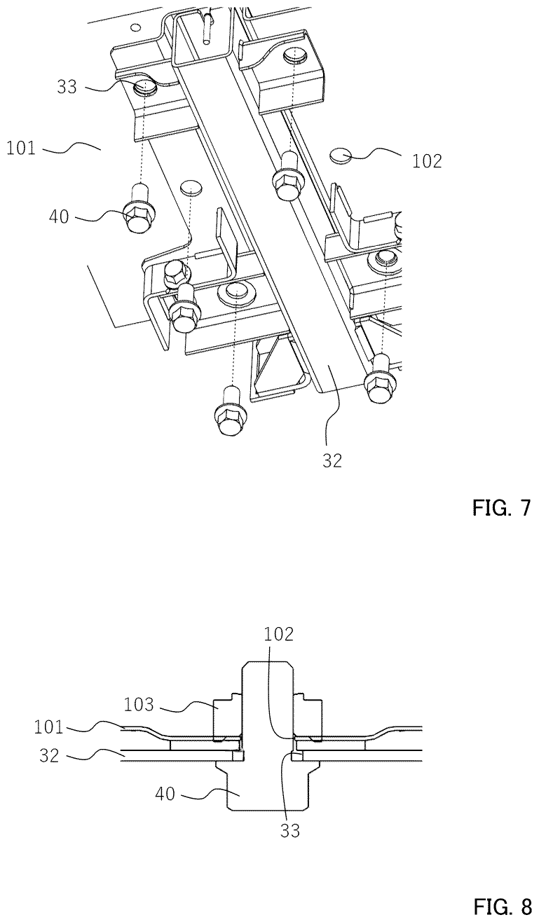

As illustrated in FIGS. 3 and 4, attachment hole 22 is formed in bottom plate 21 of battery 20, and nut 23 is firmly fixed to the inner surface (upper side in FIG. 4) of bottom plate 21 at a position corresponding to attachment hole 22 by welding or the like.

Nut member 1 is attached to bottom plate 21 by aligning through-hole 5 with attachment hole 22 from below bottom plate 21, inserting attachment bolt 10 into through-hole 5 and attachment hole 22, and screwing attachment bolt 10 into nut 23.

A predetermined number of fastening holes 33 for fastening battery 20 are formed in horizontal portion 32. Battery 20 with nut member 1 attached to the lower surface of bottom plate 21 is placed on horizontal portion 32 by aligning fastening hole 33 and female screw 4, and is fastened and attached to horizontal portion 32 by inserting fastening bolt 34 into fastening hole 33 and screwing fastening bolt 34 into female screw 4.

When the vehicle has travelled and the power of battery 20 has decreased and needs recharging, fastening bolt 34 is loosened to remove battery 20 from horizontal portion 32. At this time, nut member 1 remains attached to bottom plate 21.

Next, charged battery 20 is placed on horizontal portion 32, and fastening bolt 34 is screwed into nut member 1 attached to bottom plate 21 of charged battery 20 to attach charged battery 20 to horizontal portion 32.

When the exchange of battery 20 is repeated, female screw 4 may become worn. Nut member 1 with worn female screw 4 can be easily detached from bottom plate 21 by loosening attachment bolt 10, and a new nut member 1 can be easily attached to bottom plate 21.

FIG. 5 is a view illustrating details of nut member 51 in Embodiment 2. Nut member 51 includes nut portion 52, extension portion 53 extending laterally from a base portion (upper side in the drawing) of nut portion 52, and insertion portion 56 formed to protrude upward at a position corresponding to nut portion 52 of extension portion 53. Further, female screw 54 is formed from nut portion 52 to insertion portion 56. Through-hole 55 is formed in extension portion 53.

In comparison with nut member 1 of Embodiment 1, the length of nut portion 52 protruding downward from extension portion 53 is shorter than nut portion 2 of nut member 1. Further, the length of the combination of nut portion 52 and insertion portion 56 is approximately the same as that of nut portion 2. Female screw 54 is formed from nut portion 52 to insertion portion 56, and accordingly the length thereof is the same as that of female screw 4.

On the other hand, in bottom plate 61 of battery 60, attachment hole 62 and insertion hole 64 into which insertion portion 56 is insertable between two attachment holes 62 are formed. Nut 63 is firmly fixed by welding or the like to the inner surface (upper side in the figure) of bottom plate 61 at a position corresponding to attachment hole 62.

When nut member 51 is attached to bottom plate 61, through-hole 55 is aligned with attachment hole 62, insertion portion 56 is inserted into insertion hole 64, and nut member 51 is disposed on the lower surface of bottom plate 61. In this state, attachment bolt 10 is inserted into through-hole 55 and attachment hole 62, and screwed into nut 63, thereby attaching nut member 51 to bottom plate 61.

The procedure for attaching battery 60 to horizontal portion 32 is the same as in Embodiment 1.

In Embodiment 2, a part of nut member 51 is inserted into insertion hole 64 of bottom plate 61 as insertion portion 56, and as such the length of nut member 51 protruding downward from bottom plate 61 is shorter than that of nut member 1 in Embodiment 1. As a result, the distance between bottom plate 61 and horizontal portion 32 is shorter than that in Embodiment 1, and thus the height of the space over horizontal portion 32 required for attaching battery 60 to horizontal portion 32 is reduced, and, battery 60 can be attached in a narrower space than in Embodiment 1.

According to the battery attachment structure of the present disclosure, even if the female screw for the screwing of the fastening bolt for attaching the battery to the vehicle body frame is worn, the nut member can be easily removed from the battery and replaced.

### INDUSTRIAL APPLICABILITY

The present invention can be suitably used in a structure for attaching a battery to a vehicle body frame.

### REFERENCE SIGNS LIST

1, 51 Nut member
2, 52 Nut portion
3, 53 Extension portion
4, 54 Female screw
5, 55 Through-hole
10 Attachment bolt
20, 60 Battery
21, 61 Outer plate (bottom plate)
22, 62 Attachment hole
23, 63 Nut
30 Vehicle body frame
31 Vertical portion
32 Horizontal portion
33 Fastening hole
34 Fastening bolt
40 Fastening bolt
56 Insertion portion
64 Insertion hole
100 Battery
101 Outer plate (bottom plate)
102 Attachment hole
103 Nut

1. A battery attachment structure,
wherein a nut member is detachably attached to an outer surface of an outer plate of a battery; and
wherein the battery is fastened to a vehicle body frame by screwing a fastening bolt into the nut member, the fastening bolt being inserted in a fastening hole formed in the vehicle body frame.

2. The battery attachment structure according to claim 1,
wherein the nut member includes a nut portion in which a female screw is formed, and an extension portion extending laterally from the nut portion and including a through-hole formed in the extension portion;
wherein an attachment hole is formed in the outer plate;
wherein a nut is attached to an inner surface of the outer plate at a position corresponding to the attachment hole; and
wherein the nut member is attached to the outer plate by an attachment bolt, the attachment bolt being inserted into the through-hole and the attachment hole and screwed into the nut.

3. The battery attachment structure according to claim 2,
wherein an insertion portion is formed on a side opposite to the nut portion with respect to the extension portion in the nut member;
wherein an insertion hole configured for insertion of the insertion portion is formed in the outer plate; and
wherein the female screw is formed from the nut portion to the insertion portion.
